(19) United States
(12) Patent Application Publication
(10) Pub. No.: US 2024/0255261 A1
(43) Pub. Date: Aug. 1, 2024

(54) COMPRESSION MOLDED BALLISTIC-RESISTANT ARTICLE

(71) Applicant: DSM IP ASSETS. B.V., TE HEERLEN (NL)

(72) Inventors: Johann VAN ELBURG, Echt (NL); Harm VAN DER WERFF, Echt (NL); Reinard Jozef Maria STEEMAN, Echt (NL); Brad Alan DICKINSON, Echt (NL); Ulrich HEISSERER, Echt (NL)

(21) Appl. No.: 18/565,784

(22) PCT Filed: Jun. 3, 2022
(86) PCT No.: PCT/EP2022/065269

§ 371 Date: Nov. 30, 2023

Related U.S. Application Data
(60) Provisional application No. 63/196,925, filed on Jun. 4, 2021.

(30) Foreign Application Priority Data
Mar. 21, 2022 (EP) 22163256.5

(51) Int. Cl. F41H 5/04; B32B 5/26

(52) U.S. Cl. CPC F41H 5/0485; B32B 5/26; B32B 2250/20; B32B 2262/0253; B32B 2307/516; B32B 2307/72; B32B 2571/02

(57) ABSTRACT

The invention concerns a ballistic-resistant molded article having an areal density of at least 7.0 and at most 12.0 kg/m², comprising a consolidated stack of fibrous monolayers, each fibrous monolayer containing unidirectionally aligned high tenacity polyethylene filaments, the polyethylene filaments having a tenacity of at least 3.5 N/tex, wherein the molded article comprises between 5.0 and 20 wt % of a binder, wherein the molded article comprises at least 330 of said fibrous monolayers. The invention also relates to a ballistic-resistant sheet suitable to manufacture the molded article, wherein said ballistic-resistant sheet has an areal density of between 6 and 30 g/m² per polyethylene filament monolayer present in the ballistic-resistant sheet. The invention further relates to a ballistic-resistant molded article whit improved performance when shot under an angle of 30 degree.

The invention relates to a ballistic-resistant molded article comprising a consolidated stack of fibrous monolayers. The invention further relates to ballistic-resistant sheets suitable to manufacture such articles.

Such ballistic-resistant molded articles are well known in the art. For example, ballistic resistant helmets, inserts for ballistic resistant vests and vehicle components may comprise molded articles comprising a consolidated stack of fibrous monolayer containing unidirectionally aligned high tenacity polyethylene filaments. Reduction of weight, while maintaining ballistic performance is permitted by use of stronger fibers. An example of which is a switch from aramid-fiber based composites to ultra-high molecular weight polyethylene (UHMWPE)-based composites. However, such weight reduction has led to a reduction of other performance parameters.

EP1 699 954 describes high tenacity polyethylene yarns, achieving strength of 4.0 GPa and above. EP1 699 954 exemplifies fibrous monolayers made from yarns with a tensile strength of 4.1 GPa embedded in a rubber matrix, compression molded to form panels with good ballistic performance against diverse threats.

In contrast, WO13131996 describes a molded article comprising substantially matrix free fibrous monolayers while a plastomeric adhesive is present in-between adjacent fibrous monolayers. Also WO13131996 claims achieving a good balance of energy absorption capability and delamination behavior of the therein described ballistic-resistant panels.

The recently published WO20127187 describes increasing the structural performance, for example flexural rigidity or back face deformation of UHMWPE-based consolidated stacks of fibrous monolayers by adding hybridized layers comprising UHMWPE-fibers, a polymeric resin; and carbon fibers.

### SUMMARY

Although the ballistic-resistant panels described in the prior art offer relevant improvements in the field, it was observed that the compression molded stacks of monolayer may be further improved with respect to their performance when shot under an angle, instead of perpendicular. It was observed that panels prepared according to the prior art show satisfying performance with respect to a perpendicular shot with for example a bullet shot from an AK47 rifle such as the 7.62×39 mm Mild Steel Core. It was nevertheless observed that panels capable to meet severe standards, would show reduced performance when shot under an angle, especially at low areal densities of the panel. Such reduced performance may be expressed in a drop of the V50 when comparing the V50 determined under an angle of 30 degree from perpendicular to the V50 determined for perpendicular impacts, this angle is depicted in FIG. 2b as ‘26’. The present inventors observed performance drops of 10 to 30%, sometimes even more, especially when testing relatively light weight, high end ballistic panels. This deficiency of known ballistic-resistant panels may come as a surprise because when deviating from a perpendicular impact, the path length through the panel and the mass of perforated ballistic material increases and hence should the stopping power be superior when compared to the perpendicular situation. Although the mechanical aspects of this phenomenon are far from been understood, such behavior of ballistic-resistant panels is observed especially when light panels, i.e. panels with low areal density are tested against high energy threats such as the 7.62×39 Mild Steel Core (MSC) bullet commonly used in combination with the wide-spread AK47 weapon.

Accordingly it is the objective of the present invention to provide ballistic-resistant panels having high anti-ballistic performance at a low areal density that do not show, or at least show to a lesser extent, a drop of the V50 performance when shot at an angle of 30° (V50 [symbol] ) compared to the V50 at perpendicular conditions V50↓).

The present inventors have found that by using at least 330 fibrous monolayers in the molded ballistic-resistant articles while maintaining the overall areal density of the molded ballistic-resistant articles, the drop of V50 under an angle could be substantially reduced, avoided or even improved.

This objective is thus achieved by a ballistic-resistant molded article having an areal density (AD) of at least 7.0 and at most 12.0 kg/m², comprising a consolidated stack of fibrous monolayers, each fibrous monolayer containing unidirectionally aligned high tenacity polyethylene filaments, whereby the direction of orientation of the polyethylene filaments in two adjacent fibrous monolayers in the stack differs by at least 40 and up to 90 degree, the polyethylene filaments having a tenacity of at least 3.5 N/tex, wherein the molded article comprises between 5.0 and 20 wt % of a binder, based on the total weight of the molded article,

characterized in that the molded article comprises at least 330 of said fibrous monolayers.

Such ballistic-resistant molded article was found to outperform the behavior under non-perpendicular ballistic impact molded articles of similar areal density but constructed from fewer fibrous monolayers. Such solutions to the encountered problem is counter-intuitive. In case the performance of a ballistic-resistant article is not sufficient, typically additional fibrous monolayers are added to boost the protection to the required level. The present inventors identified that it is not per see required to increase the amount of ballistic-resistant material but rather to divide the available ballistic material over a larger number of cross-plied individual fibrous monolayers. The obtained articles of improved performance are hence lighter than the solutions to date.

### BRIEF DESCRIPTION OF FIGURES

FIG. 1—is a schematical drawing of part of the molded article of the invention (10) depicting parts of three stacked fibrous monolayers (11) comprising high tenacity polyethylene filaments (12).

FIG. 2 shows top views of the testing setup to determine V50 performance of molded articles of the invention under perpendicular (FIG. 2a) and non-perpendicular (FIG. 2b) conditions. The figure is further described in the METHODS under Ballistic performance of molded articles.

FIG. 3 schematically shows the testing setup of filament properties and is further described in the METHODS under Determination of filament linear density and mechanical properties.

### DETAILED DESCRIPTION

In the context of the present invention a molded article is understood to be an article that has been shaped by compression resulting in a consolidation of the monolayers into a monolithic product such as a panel, a curved panel, a helmet shell or the like. Consolidation may be done by the use of pressure and elevated temperature on a stack of fibrous monolayers, or preassembled sheets comprising said fibrous monolayers. Pressure for consolidation may for example be more than 2 bar, more than 10 bar or even 20 bar or higher while temperature during consolidation typically is in the range from 60 to 150° C. By consolidated is herein understood that the stack of monolayers is compressed to form monolithic articles such as a panel or a helmet shell. In such monolithic article the stacking of the individual monolayers would still be discernable while not being able to separate from one another without substantial effort and degradation thereof.

By the term fibrous monolayer is herein understood a monolayer comprising fibers, i.e. obtained by a process wherein fibers are used as a precursor material. The fibers of the fibrous monolayers may be mechanically modified or not. Examples of fibrous monolayers are composite layers comprising filaments and a binder holding the filaments of the monolayer together or a monolayer of mechanically fused filaments and substantially free of a binder between the filaments of the monolayers. A fibrous monolayer is structurally different from a non-fibrous monolayer, which may for example be obtained by compressing polymeric powders or spinning a solution or a melt of polymer to form a film, tape or monolayer. In such latter monolayers, no filaments are discernable and/or no filaments have been employed to produce the monolayers. The cross-section of a fibrous monolayer according to the invention, ideally if observed with a microscope, possesses boundaries between the filaments forming the monolayer. Accordingly fibrous monolayers in the context of the present invention stand in contrast to other ballistic resistant form factors such as unidirectionally aligned tapes or films.

In the context of the present invention, the fibrous monolayers contain unidirectionally aligned high tenacity polyethylene filaments, also referred to as unidirectional monolayer, hereby is understood that the monolayer comprises unidirectionally oriented filaments, i.e. filaments that are essentially oriented parallel to one another. A unidirectional monolayer typically contains one or more superimposed parallel filaments to make up the thickness of said unidirectional monolayer.

The compression molded article of the invention comprises a stack of a plurality of unidirectional monolayers, adjacent one to another, while the direction of the filaments in a monolayer is rotated with a certain angle with respect to the direction of the filaments in the adjacent monolayers. Said angle is at least 40° and up to 90°, more preferably the angle is at least 70°, more preferably at least 80° and most preferably the angle is about 90°.

The compression molded article of the invention may have been obtained by stacking the required amount of corresponding fibrous monolayers, nevertheless, the stack may have been built from pre-assembled sheets comprising at least 2 of said monolayers. The sheet may comprise more than 2 monolayers of unidirectionally aligned filaments, whereby the filament direction in each monolayer is being rotated with respect to the filament direction in an adjacent monolayer by an angle of at least 40° as indicated above. Preferably a set of 2, 4, 6, 8 or 10 monolayers may be pre-assembled to a sheet by consolidation of the stack of monolayers. Preferably such sheet contains aligned high tenacity filaments in substantially two directions of orientations, also called the 0° and the 90° orientation. Consolidation of the pre-assembled sheet may be done by the use of pressure and elevated temperature to form the sheet. Pressure for consolidation may for example be more than 2 bar, more than 10 bar or even 20 bar or higher while temperature during consolidation typically is in the range from 60 to 150° C.

In the context of the present invention high tenacity polyethylene filaments are understood to be polyethylene filaments with a tenacity of at least 3.5 N/tex. In a preferred embodiment, the ballistic-resistant molded article and the ballistic-resistant sheets of the invention the high tenacity polyethylene filaments have a tenacity of at least 3.8, preferably at least 4.0, more preferably at least 4.2, even more preferably at least 4.5 N/tex and most preferably at least 4.8 N/tex. The skilled person will be aware that there are theoretical and practical limits to the tenacity of the high tenacity polyethylene filaments, therefor the high tenacity polyethylene filaments preferably have a tenacity of at most 8.0, preferably at most 7.0, more preferably at most 6.0 N/tex. Preferred polyethylene is ultrahigh molecular weight polyethylene (UHMWPE). Best results were obtained when the high tenacity polyethylene filaments comprise ultra-high molecular weight polyethylene (UHMWPE) and have a tenacity of at least 3.5 N/tex, more preferably at least 4.0 N/tex and most preferably at least 4.2 N/tex. The inventors observed that for UHMWPE the best ballistic performances could be achieved.

By filament is herein understood an elongated body, the length dimension of which is much greater than the transverse dimensions of width and thickness, or diameter. Typically a filament is referred to as having a continuous length. In the context of the present invention, filament may as well be referred to as fiber. The in the art recognized form factor of staple fibers having discontinuous length is not considered a filament in the context of the present invention. A filament may have regular or irregular cross-sections, typically the cross-section is circular, but may also be polygonal, oval or oblong. Especially once processed into the monolayers of the present invention, the shape of the cross-section may have been altered by the processing conditions. A yarn for the purpose of the invention is an elongated body containing many individual filaments.

The filaments present in the monolayers may have a linear density, typically referred to as titer, of at most 6.0 dtex, preferably at most 4.0 dtex, more preferably at most 3.0 dtex, even more preferably of at most 2.0 and most preferably of at most 1.0 dtex. It was observed that filaments with lower titers show improved ballistic 5 performance and allow manufacture of more homogeneous fibrous monolayers. In a further preferred embodiment, the filaments present in the monolayers have a linear density of at least 0.1 dtex, preferably at least 0.2 dtex and most preferably at least 0.4 dtex. Such lower limits are caused by economics and technology of current manufacturing processes.

The fibrous monolayers, or the therefrom produced sheets and/or the ballistic-resistant article of the invention also comprise a binder, also referred to as matrix or adhesive in the context of the present invention. The total amount of binder present in the article is less than 20.0 wt. % based on the weight of the article. In a preferred embodiment, the total amount of binder present in the molded ballistic-resistant article is from 6.0 to 11.0 wt. % based on the total weight of the stack. More preferably, the total amount of binder present is from 7.0 to 10.5 wt. %; more preferably from 7.5 to 10.0 wt. %; most preferably from 8.0 to 9.5 wt. % based on the total weight of the stack. In another preferred embodiment, the total amount of binder present in the molded ballistic-resistant article is from 11.0 to 19.0 wt. % based on the total weight of the stack. More preferably, the total amount of binder present is from 12.0 to 18.0 wt. %; more preferably from 13.0 to 17.0 wt. %; most preferably from 14.0 to 16.5 wt. % based on the total weight of the stack. Said binder material may be present in in the fibrous monolayers in between the high tenacity filaments, typically then called matrix, or in between the fibrous monolayers, typically then called adhesive. Various binders may be used, examples thereof including thermosetting and thermoplastic materials. A wide variety of thermosetting materials are available, however, epoxy resins or polyester resins are most common. Suitable thermosetting and thermoplastic materials are enumerated in, for example, WO 91/12136 A1 (pages 15-21) included herein by reference. From the group of thermosetting materials, vinyl esters, unsaturated polyesters, epoxides or phenol resins are preferred. From the group of thermoplastic materials, polyurethanes, polyvinyls, polyacrylics, polybutyleneterephthalate (PBT), polyolefins or thermoplastic elastomeric block copolymers such as polyisopropene-polyethylene-butylene-polystyrene or polystyrene-polyisoprene-polystyrene block copolymers are preferred.

By areal density is understood the weight of a given area of a sample divided by its surface area, expressed in kilogram per square meter [kg/m²] or gram per square meter [g/m²]. For substantially flat articles, the weight of a sample may be divided by its surface area, nevertheless, a more general method is provided to account for curved and more complex shaped articles by multiplying the average thickness by the specific density of the molded article. As used herein, average thickness is measured by taking at least 5 measurements distributed over the article, each measurement spaced apart from the other measurements by at least 5 cm, and calculating the mean value. As used herein, specific density of the molded article is measured by weighing a sample of the compression molded article and dividing it by the volume of said sample.

The polyethylene is preferably of ultra-high molecular weight (UHMWPE) with an intrinsic viscosity (IV) of at least 4 dl/g; more preferably of at least 8 dl/g, most preferably of at least 12 dl/g. Intrinsic viscosity is a measure for molecular weight that can more easily be determined than actual molar mass parameters like number and weight average molecular weights (Mn and Mw).

In an alternative embodiment, the fibrous monolayers, or the therefrom produced sheets and/or the ballistic-resistant article of the invention may also comprise further filaments, other than the above high tenacity polyethylene filaments. Herewith are understood further high tenacity filaments other than manufactured from polyethylene, such as inorganic materials like carbon fiber, mineral fibers and glass fibers or organic fibers manufactured from a polymer chosen from the group consisting of polyarnides and polyaramides, e.g. poly(p-phenylene terephthalamide) (known as Kevlar®); poly(tetrafluoroethylene) (PTFE); poly{2,6-diimidazo-[4,5b-4′,5′e]pyridinylene-1,4(2,5-dihydroxy)phenylene} (known as M5); poly(p-phenylene-2,6-benzobisoxazole) (PBO) (known as Zylon®); liquid crystal polymers (LCP); poly(hexamethyleneadipamide) (known as nylon 6,6), poly(4-aminobutyric acid) (known as nylon 6); polyesters, e.g. poly(ethylene terephthalate), poly(butyleneterephthalate), and poly(1,4 cyclohexylidene dimethylene terephthalate); polyvinyl alcohols; and also polyolefins e.g. homopolymers and copolymers propylene. Preferably such further filaments are present in at least one further monolayer comprising said second said further filament, optionally with a binder or sheet comprising several of such monolayers. This layer may be placed on the inner or outer surface of the stack of layers, or between two monolayers of the stack or a combination thereof, for example alternating with the cross-plied fibrous monolayers of unidirectionally aligned high performance polyethylene filaments. The further filaments may be chosen from the listed range. Preferably the further filaments is an inorganic fiber. Most preferably, the further filament is carbon fiber.

One method for the production of the high tenacity polyethylene filaments used in the invention comprises feeding the polyethylene to an extruder, extruding a filament at a temperature above the melting point thereof and drawing the extruded filament below its melting temperature. If desired, prior to feeding the polymer to the extruder, the polymer may be mixed with a suitable liquid compound, for instance to form a gel, such as is preferably the case when using ultra high molecular weight polyethylene.

In a preferred method the filaments used in the invention are prepared by a gel spinning process. A suitable gel spinning process is described in for example GB-A-2042414, GB-A-2051667, EP 0205960 A and WO 01/73173 A1. In short, the gel spinning process comprises preparing a solution of a polyethylene of high intrinsic viscosity, extruding the solution into a solution-filament at a temperature above the dissolving temperature, cooling down the solution-filament below the gelling temperature, thereby at least partly gelling the polyethylene of the filament, and drawing the filament before, during and/or after at least partial removal of the solvent.

In the described methods to prepare high tenacity filaments drawing, preferably uniaxial drawing, of the produced filaments may be carried out by means known in the art. Such means comprise extrusion stretching and tensile stretching on suitable drawing units. To attain increased mechanical tensile strength and stiffness, drawing may be carried out in multiple steps.

In case of the preferred UHMWPE filaments, drawing is typically carried out uniaxially in a number of drawing steps. The first drawing step may for instance comprise drawing to a stretch factor (also called draw ratio) of at least 1.5, preferably at least 3.0. Multiple drawing may typically result in a stretch factor of up to 9 for drawing temperatures up to 120° C., a stretch factor of up to 25 for drawing temperatures up to 140° C., and a stretch factor of 50 or above for drawing temperatures up to and above 150° C. By multiple drawing at increasing temperatures, stretch factors of about 50 and more may be reached. This results in high tenacity polyethylene filaments, whereby for ultrahigh molecular weight polyethylene, tenacities of 3.5 N/tex and more may be obtained.

As mentioned, it was observed that state of the art panels capable to meet severe standards show inadequate performance when shot under an angle. Especially for high end grades this becomes apparent when lower panel areal densities and thickness are enabled through their good ballistic performance under perpendicular impact conditions. Accordingly the present invention is especially relevant for anti-ballistic panels with reduced areal densities. Therefor a preferred embodiment of the present invention concerns ballistic-resistant molded articles wherein the molded article has an AD of at most 11.0, preferably of at most 10.5, more preferably of at most 10.2 and most preferably of at most 9.9 kg/m². It was observed that increasing the number of monolayers is especially advantageous at these lower areal densities of the ballistic-resistant molded article. It reduces or cancels the deficit of state of the art materials in catching projectiles Impacting under an angle. Accordingly the present invention makes low weight anti-ballistic solutions available that show high V50 performances under both perpendicular and non-perpendicular conditions.

It was further observed that not only the areal density of the ballistic-resistant article according to the present invention could be reduced, but that—surprisingly—the improvement is also observed when the amount of ballistic filaments present in the ballistic-resistant article is reduced. Therefor a preferred embodiment of the present invention concerns a ballistic-resistant molded article wherein the molded article has an areal density of polyethylene filaments of between 6.0 and 10.0 kg/m². Preferably the areal density of polyethylene filaments in the ballistic resistant molded article is between 6.0 and 9.5 kg/m², more preferably between 6.5 and 9.0 kg/m². The areal density of polyethylene filaments in the article is understood to be the mass of the polyethylene of the high tenacity polyethylene filaments present in a given area of the molded article divided by its surface area, expressed in kilogram per square meter. The areal density of polyethylene filaments may also be computed based on the areal density of the article, multiplied by the mass fraction of polyethylene present therein. Merely as an example, if the fibrous monolayer comprises 87 wt % of polyethylene filaments and 13 wt % of matrix, the areal density of polyethylene filaments is 0.87 times the areal density of the article.

In a preferred embodiment of the invention, the fibrous monolayers present in the ballistic-resistant molded article have an areal density of between 6 and 30 g/m², preferably between 8 and 28 g/m², more preferably between 10 and 26 g/m², and most preferably between 12 and 24 g/m². Monolayers with low areal densities will allow to further increase the number of monolayers present in a ballistic-resistant article of a given areal density and positively affect the V50 [symbol] performance thereof. The lower limit of the monolayer areal density is given by thickness of the filaments present therein as well as production efficiency, since low areal density monolayer will negatively impact equipment output. The upper boundaries of the monolayer areal density are given by the requirement to build the ballistic-resistant article from a minimum amount of monolayers. Too heavy monolayers will not show the required performance improvement under non-perpendicular impact conditions. In the context of the present invention, the areal density of a monolayer may also be referred to as weight of the monolayer and is expressed in gram per square meter [g/m]. Such areal density is measured by weighing a given portion of the monolayer and dividing it by its surface area. The areal density may also be derived from the areal density of a compression molded anti-ballistic article, divided by the number of monolayers it comprises.

In a preferred embodiment the fibrous monolayers of the ballistic-resistant article have an areal density of polyethylene filaments between 4 and 28 g/m², preferably between 6 and 26 g/m², more preferably between 8 and 25 g/m², and most preferably between 10 and 24 g/m². It was identified that such amount of high tenacity filaments present in the monolayer is provides a good compromise between production economics and improvement of the non-perpendicular impact performance. The areal density of polyethylene filaments in the monolayer is understood to be the mass of the polyethylene of the high performance polyethylene filaments present in a given area of the monolayer divided by its surface area, expressed in gram per square meter. The areal density of polyethylene filaments may also be computed based on the areal density of the monolayer, multiplied by the mass fraction of polyethylene present in or on the monolayer.

The ballistic-resistant molded article of the invention comprises at least 330 fibrous monolayers. It was observed that high number of monolayers present in a ballistic-resistant article of a given areal density postively affect the V50 [symbol] performance thereof, especially resulting in a V50 [symbol] similar if not superior to the V50↓. The upper limit of the number of monolayers is dictated by the lower limit of monolayer areal density and production economics. Large amounts of, say up to 1000 or more monolayers may be combined and compression molded to a ballistic-resistant article but may be experienced as a cumbersome and financially unattractive product. Ballistic-resistant articles with at most 800 or preferably at most 700 monolayers may be commercially more realistic products, while preferably the ballistic-resistant article comprises between 330 and 600, more preferably 350 and 550 monolayers, most preferably between 370 and 500 monolayers. The number of monolayers in a ballistic-resistant article can readily be established by means known in the art such as manual delamination or microscopic Imaging of cross-sections of the article.

A preferred embodiment of the present invention concerns a ballistic-resistant molded article comprising fibrous monolayers wherein the monolayers are composite monolayers of the unidirectionally aligned high tenacity polyethylene filaments and the binder. Such composite monolayers and their manufacture are generally known in the art as for example described in WO2005066401 and WO2017060469, which are herein included by reference. Preferably the process comprises applying the binder, also referred to as matrix, in any form, such as a solution, an emulsion or an aqueous dispersion of the matrix to the fibrous monolayers of the unidirectionally aligned high tenacity polyethylene filaments. The obtained impregnated fibrous monolayers will be dried to form composite monolayers. Said composite monolayers may on their turn be pre-assembled to form composite sheets by cross-plying and compression molding 2 or more composite monolayers as detailed above. Accordingly, such composite sheets comprises at least two stacked, adjacent fibrous monolayers of unidirectionally aligned high tenacity polyethylene filaments embedded in a binder. Herewith is understood that the filaments are in a parallel array arrangement also known as unidirectional (UD) arrangement, which may be obtained by any of a variety of conventional techniques. The binder will be present throughout the composite fibrous monolayer, substantially embedding the filaments therein and binding the filaments of the monolayer together.

Another preferred embodiment of the present invention concerns ballistic-resistant molded article comprising fibrous monolayers being substantially free of binder and wherein adjacent fibrous monolayers are adhered to each other by layers of the binder. Accordingly the fibrous monolayer is substantially free of any binder or matrix material between the polyethylene filaments of said fibrous monolayer. It was observed that in the absence of binders or matrix materials, the ballistic properties of the ballistic-resistant article of the invention may be improved. By substantially free is understood that the fibrous monolayer comprise less than 3.0 wt %, preferably less than 2.0 wt %, more preferably less than 1.0 wt % and most preferably less than 0.5 wt % of binder relative to the mass of the fibrous monolayer.

A fibrous monolayer of unidirectionally aligned high tenacity polyethylene filaments which monolayer is substantially absent of a bonding matrix is typically formed by fusion of filaments. Fusing is preferably achieved under a combination of pressure, temperature and time which results in substantially no melt bonding. Preferably, there is no detectable melt bonding as detected by DSC (10° C./min). No detectable melt bonding means that no visible endothermic effect consistent with partially melted recrystallized UHMWPE filaments is detected, when the sample is analyzed in triplicate. Preferably, fusing is mechanical fusing. Mechanical fusing is thought to occur by deformation of filaments leading to increased mechanical interlocking of parallel arranged filaments and increased van der Waals interaction between filaments. Accordingly, the filaments within a layer are typically fused. Therefore, the monolayer may have good structural stability without any bonding matrix or adhesive being present. Further, it may have good structural stability without any melting of filaments having taken place during the filament fusing process. By good structural stability is understood that the monolayers show robust handling performance for example in that the monolayers do not fibrillate or tear apart when stacks thereof are prepared. Structural stability might be expressed as the strength of the monolayer in its width direction, or transversal strength. Such strength should be above 0.1, better 0.2 MPa

A monolayer of unidirectionally oriented polyethylene filaments substantially absent a bonding matrix may be formed by subjecting a parallel array of filaments to elevated temperature and pressure. The means for applying pressure may be a calender, a smoothing unit, a double belt press or an alternating press. A preferred manner of applying pressure is by introducing an array of unidirectionally oriented filaments to the nip of calender, substantially as described in WO 2012/080274 A1.

Preferably, the thickness of the monolayer comprising unidirectionally aligned polyethylene filaments is at least 1.0, more preferably at least 1.3, most preferably at least 1.5 times the thickness of individual polyethylene filaments. If polyethylene filaments with different thicknesses are used, by the thickness of an individual filament is herein understood an average thickness of the utilized filaments. Preferably, the maximum thickness of said layer is no more than 10, more preferably no more than 8, even more preferably no more than 5 and most preferably no more than 3 times the thickness of individual polyethylene filaments.

Typically, a monolayer of unidirectionally aligned polyethylene filaments substantially free of binder has a thickness of from 4 to 28 μm, preferably between 6 and 26 μm, more preferably between 8 and 25 μm, and most preferably between 10 and 24 μm. Thickness of a layer may be measured by taking an average of three measurements, for example using microscopy.

In the present embodiment of the invention, the adjacent fibrous monolayers substantially absent of a binder are adhered to each other by said binder. The ballistic-resistant article is formed from at least 330 fibrous monolayers. It may comprise only identical monolayers, or a mixture of different monolayers.

The term binder, in the present context also called adhesive, refers to a material that binds adjacent monolayers of unidirectionally aligned filaments together. The adhesive may provide structural rigidity to the monolayers or pre-assembled sheets of multiple cross-plied monolayers. It also acts to improve inter-layer bonding between adjacent monolayers of unidirectionally aligned filaments in the molded article of the present invention. In the molded article of the present invention, the adhesive forms an intermediate layer between adjacent monolayers of unidirectionally aligned polyethylene filaments. The adhesive may completely cover a surface of an adjacent layer of unidirectionally aligned filaments or it may only partially cover said surface. The adhesive can be applied in various forms and ways; for example as a film, as transverse bonding strips or transverse fibres (transverse with respect to the unidirectional filaments), or by coating the layer of unidirectionally aligned polyethylene filaments, e.g. with a polymer melt or a solution or dispersion of a polymer material in a liquid. Preferably, the adhesive is homogeneously distributed over the entire surface of the layer, whereas a bonding strip or bonding fibres can be applied locally.

A suitable binder includes a thermosetting polymer or a thermoplastic polymer, or a mixture of the two. Thermosetting polymers include vinyl esters, unsaturated polyesters, epoxides or phenol resins. Thermoplastic polymers include, polyurethanes, polyvinyls, polyacrylics, polyolefins, polybutyleneterephthalate (PBT), or thermoplastic elastomeric block copolymers such as polystyrene-polybutylene-polystyrene or polystyrene-polyisoprene-polystyrene block copolymers. From the group of thermosetting polymers, vinyl esters, unsaturated polyesters, epoxides or phenol resins are preferred.

A preferred thermoplastic polymer comprises a copolymer of ethylene which may contain as co-monomers one or more olefins having 2 to 12 C-atoms, in particular ethylene, propylene, isobutene, 1-butene, 1-hexene, 4-methyl-1-pentene, 1-octene, acrylic acid, methacrylic acid and vinyl acetate. In the absence of co-monomer in the polymeric resin, a wide variety of polyethylene may be present, for example linear low density polyethylene (LLDPE), very low density polyethylene (NLDPE), low density polyethylene (LDPE), or blends thereof. However, high density polyethylene (HDPE) is preferred.

One particularly preferred thermoplastic polymer comprises a copolymer of ethylene and acrylic acid (ethylene acrylic acid copolymer); or a copolymer of ethylene and methacrylic acid (ethylene methacrylic acid copolymer). Preferably, said adhesive is applied as an aqueous suspension.

An alternative particularly preferred thermoplastic polymer is a plastomer wherein said plastomer is a random copolymer of ethylene or propylene and one or more C₂ to C₁₂ α-olefin co-monomers. More preferably, the thermoplastic polymer is a homopolymer or copolymer of ethylene and/or propylene.

The melting point of the adhesive is below that of the polyethylene filaments. Typically, the adhesive has a melting point below 155° C. Preferably it is from 115° C. to 150° C.

The adhesive typically does not penetrate substantially into the monolayers of unidirectionally aligned polyethylene filaments. Preferably, the adhesive does not penetrate at all into the monolayers. Accordingly, the adhesive does not act as a bonding agent between filaments within a single monolayer of unidirectionally aligned filaments. Preferably the ballistic-resistant molded article comprises a plurality of layers of unidirectionally aligned polyethylene filaments which monolayers are substantially absent a bonding matrix; and a plurality of layers of adhesive present in between said adjacent monolayers. Preferably the adhesive is present in between all adjacent monolayers of polyethylene filaments.

For the inventive embodiment of ballistic-resistant molded article comprising fibrous monolayers being substantially free of binder and wherein the adjacent fibrous monolayers are adhered to each other by a binder, the molded article may be formed by alternately stacking the required number of monolayers comprising polyethylene filaments and adhesive layers, while such process would be cumbersome in view of the high amount of layers present in the final article. An intermediate product in the form of sheets comprising a certain number of monolayers of unidirectionally aligned filaments alternating with adhesive layers represents hence an interesting intermediate product to simplify the manufacture of the ballistic-resistant molded article of the invention.

Therefor an embodiment of the invention concerns a ballistic-resistant sheet comprising at least 2 fibrous monolayers, each fibrous monolayer containing unidirectionally aligned high tenacity polyethylene filaments, whereby the direction of orientation between the polyethylene filaments of two adjacent fibrous monolayers in the sheet differ by at least 40 and up to 90 degree, the polyethylene filaments having a tenacity of at least 3.5 N/tex, wherein the ballistic-resistant sheet comprises between 5.0 and 20 wt % of a binder based on the total weight of the ballistic-resistant sheet, wherein the fibrous monolayers are substantially free of binder and wherein adjacent fibrous monolayers are adhered to each other by a layer of the binder, wherein said ballistic-resistant sheet has an areal density (AD) of between 6 and 30 g/m² per polyethylene filament monolayer present in the ballistic-resistant sheet, preferably between 8 and 28 g/m² and more preferably between 10 and 26 g/m². Accordingly the ballistic-resistant sheet has preferably an areal density between 12 and 60 g/m² for a 2 monolayer comprising sheet, of between 24 and 120 g/m² for a 4 monolayer comprising sheet, of between 36 and 180 g/m² for a 6 monolayer comprising sheet and of between 48 and 240 g/m² for a 8 monolayer comprising sheet. More preferably the ballistic-resistant sheet has an areal density (AD) of between 16 and 56 g/m² for a 2 monolayer comprising sheet, of between 32 and 112 g/m² for a 4 monolayer comprising sheet and of between 48 and 168 g/m² for a 6 monolayer comprising sheet and of between 64 and 224 g/m² for a 8 monolayer comprising sheet, more preferably the ballistic-resistant sheet has an areal density (AD) of between 20 and 52 g/m² for a 2 monolayer comprising sheet, of between 40 and 104 g/m² for a 4 monolayer comprising sheet and of between 60 and 156 g/m² for a 6 monolayer comprising sheet and of between 80 and 208 g/m² for a 8 monolayer comprising sheet.

In the ballistic-resistant article or sheet of the present embodiment the adhesive layer may comprise a complete layer, for example a film; a continuous partial layer, for example a web; or a disperse partial layer, for example spots or islands of adhesive.

The amount of binder in the ballistic-resistant sheet according to the present embodiment of the invention may vary within wide ranges and will especially depend upon the required final properties of the ballistic-resistant curved molded article as well as the nature of the polyethylene filaments present in the monolayers. Typically the amount of binder present in the ballistic-resistant sheet is between 5.0 and 20 wt %. In a preferred embodiment said concentration of binder between 6.0 and 17 wt %, preferably between 7.0 and 14 wt %, most preferably between 8.0 and 12 wt %, whereby the weight percentage is the weight of binder to the total weight of the ballistic-resistant sheet.

The ballistic-resistant molded articles according to the present invention have outstanding anti-ballistic performance at low areal densities of the molded article against a variety of projectiles, amongst which the threat commonly known as AK47 bullet, more precisely the 7.62×39 mm MSC, when shot under standard, perpendicular conditions, i.e. a shot impacting the article perpendicular at the position of impact. Amongst others, the ballistic-resistant molded articles of the invention may outperform on a weight basis ballistic performance of state of the art solutions. Accordingly a preferred embodiment concerns a ballistic-resistant molded article of the invention wherein the molded article has a V50 when shot under perpendicular conditions (V50↓) of at least 600 m/s when tested against an AK47 7.62×39 mm MSC projectile. Preferably the V50 under said conditions is at least 650 m/s, more preferably at least 700 m/s and most preferably at least 750 m/s. The V50↓ of the article may reach ballistic performance of at most 1100 m/s or even higher, preferably the at most 1150 m/s, more preferably at most 1200 m/s and most preferably at most 1250 m/s.

But more importantly the inventors observed that the ballistic performance of the ballistic-resistant molded article according to the invention also show outstanding anti-ballistic performance at low areal densities of the molded article against a variety of projectiles, amongst which the threat commonly known as AK47 bullet, more precisely the 7.62×39 mm MSC when shot under an angle, such as a shot hitting at an angle deviating by 30° from the perpendicular impact. Amongst others, the ballistic-resistant molded articles of the invention may outperform on a weight basis ballistic performance of state of the art solutions. Accordingly a preferred embodiment concerns a ballistic-resistant molded article of the invention wherein the molded article has a V50 when shot at an angle of 30° from perpendicular (V50 [symbol] ) of at least 580 m/s when tested against an AK47 7.62×39 mm MSC projectile. Preferably the V50 under said conditions is at least 630 m/s more preferably at least 680 m/s and most preferably at least 730 m/s. The V50 [symbol] of the article may reach ballistic performance of at most 1100 m/s or even higher, preferably the at most 1150 m/s, more preferably at most 1200 m/s and most preferably at most 1250 m/s.

While both the ballistic performance under perpendicular conditions, expressed as V50↓, and under an angle, expressed as V50 [symbol] are relevant performance characteristics when designing anti-ballistic armors, an even more relevant characteristic is that the anti-ballistic performance of an armor does not substantially change when shot at different angles, since in the field it is hardly predictable from which position an armor is impacted while said armor should provide the same level of protection over a broad angle of impact. It is the core achievement of the present inventors to develop an anti-ballistic molded article that does not suffer from a loss of performance when hit in a non-perpendicular manner. Therefor a preferred embodiment concerns a ballistic-resistant molded article according to the present invention wherein the ratio of the V50 [symbol] to V50↓ is at least 0.95, preferably at least 0.98, more preferably at least 1.00 and most preferably at least 1.05. Although the phenomenon is not readily understood, ideally the ballistic performance under an angle of 30 degrees expressed as V50 [symbol] could be substantially better due to the higher mass of ballistic material to perforate. Therefor the ratio of the V50 [symbol] to V50↓ may be as high as 1.3 or preferably 1.4. Such ballistic-resistant articles will be utmost suitable to design armor with valuable protection under various applications and threats and are hitherto unavailable showing the herein achieved V50 [symbol] and V50 ↓ performance levels at in the relevant areal densities range.

Therefor the present invention also concerns ballistic-resistant molded article wherein said molded article has an areal density (AD) of between 7.0 and 12.0 kg/m² and comprising a consolidated stack of fibrous monolayers, each fibrous monolayer containing unidirectionally aligned high tenacity polyethylene filaments, whereby the direction of orientation between the polyethylene filaments of two adjacent fibrous monolayers in the stack differs by at least 40 and up to 90 degree, the polyethylene filaments having a tenacity of at least 3.5 N/tex, wherein the molded article comprises between 5.0 and 20 wt % of a binder based on the total weight of the molded article, and wherein the ratio of the V50 [symbol] to V50↓ of the ballistic-resistant molded article is at least 0.95, preferably 0.98, more preferably at least 1.00 and most preferably at least 1.05. Preferably, the fibrous monolayers of the ballistic-resistant molded article are composite monolayers of the unidirectionally aligned high tenacity polyethylene filaments and the binder. In an alternative preferred embodiment, the fibrous monolayers of the ballistic-resistant molded article are substantially free of binder and the adjacent fibrous monolayers are adhered to each other by layers of the binder.

A preferred field of application of the ballistic-resistant molded article of the invention is in the field of ballistic resistant articles such as armors. The function of a ballistic resistant article is two-fold, it should stop fast projectiles, and it should do so with a minimum back face deformation. Back face deformation is effectively the size of the impact dent measurable on the non-impact side of the article. Typically it is measured in mm of greatest deformation perpendicular to the plane of the impacted surface of the ballistic resistant article. It was surprisingly observed that the size of the impact dent is small, if composite sheets made according to the present invention are used in armor. In other words, the back face signature is small. Such armor is especially suitable for combat helmet shells, because they show reduced back face signature on stopping projectiles, thus reducing trauma on the human skull and brain after being hit by a stopped projectile.

The invention is further explained by means of the following examples, without being limited thereto.

Test methods as referred to in the present application, are as follows:
IV: the Intrinsic Viscosity is determined according to method ASTM D1601(2004) at 135° C. in decalin, the dissolution time being 16 hours, with BHT (Butylated Hydroxy Toluene) as anti-oxidant in an amount of 2 g/l solution, by extrapolating the viscosity as measured at different concentrations to zero concentration.
Determination of filament linear density and mechanical properties (Filament tenacity and filament tensile modulus) is carried out on a semiautomatic, microprocessor controlled tensile tester (Favimat, tester no. 37074, from Textechno Herbert Stein GmbH & Co. KG, Mdnchengladbach, Germany) which works according to the principle of constant rate of extension (DIN 51 221, DIN 53 816, ISO 5079) with integrated measuring head for linear density measurement according to the vibroscopic testing principle using constant tensile force and gauge length and variable exciting frequency (ASTM D 1577). The Favimat tester is equipped with a 1200 cN balance, no. 14408989. The version number of the Favimat software: 3.2.0.

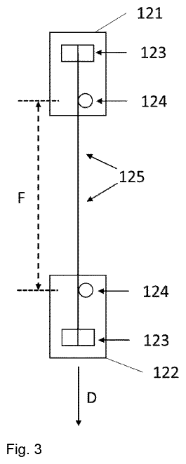

Clamp slippage during filament tensile testing, preventing filament fracture, is eliminated by adaption of the Favimat clamps according to FIG. 3.

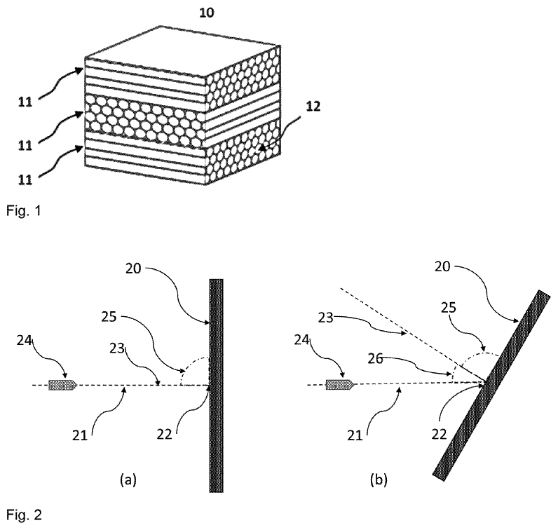

The upper clamp 121 is attached to the load cell (not shown). The lower clamp 122 moves in downward direction (D) with selected tensile testing speed during the tensile test. The filament (125) to be tested, at each of the two clamps, is clamped between two jaw faces 123 (4×4×2 mm) made from Plexiglass® and wrapped three times over ceramic pins 124 and 125. Prior to tensile testing, the linear density of the filament length between the ceramic pins is determined vibroscopically. Determination of filament linear density is carried out at a filament gauge length (F) of 50 mm (see FIG. 2), at a pretension of 2.50 cN/tex (using the expected filament linear density calculated from yarn linear density and number of filaments). Subsequently, the tensile test is performed at a test speed of the lower clamp of 25 mm/min with a pretension of 0.50 cN/tex, and the filament tenacity is calculated from the measured force at break and the vibroscopically determined filament linear density. The elongational strain is determined by using the whole filament length between the upper and lower plexiglass jaw faces at the defined pretension of 0.50 cN/tex. The beginning of the stress-strain curve shows generally some slackness and therefore the modulus is calculated as a chord modulus between two stress levels. The Chord Modulus between e.g. 10 and 15 cN/dtex is given by equation (1):

$$Chord Modulus between 10 and 15 cN / dtex = CM ( 10 : 15 ) = \frac{50}{{ε}_{15} - {ε}_{10}} ( N / tex ) \qquad ( 1 )$$

where:
ε₁₀=elongational strain at a stress of 10 cN/dtex (%); and
ε₁₅=elongational strain at a stress of 15 cN/dtex (%).

The measured elongation at break is corrected for slackness as by equation (2):

$$EAB = EAB ( measured ) - ( {ε}_{5} - \frac{50}{C M ( 5 : 10 )} ) \qquad ( 2 )$$

where:
EAB=the corrected elongation at break (%)
EAB (measured)=the measured elongation at break (%)
ε₅=elongational strain at a stress of 5 cN/dtex (%)
CM(5:10)=Chord Modulus between 5 and 10 cN/dtex (N/tex).
Areal density (AD) of a panel, sheets or monolayer was determined by measuring the weight of a sample of preferably 0.4 m×0.4 m with an error of 0.1 g.
Ballistic performance of molded articles was determined by calculating the V50 value of 8 individual shots on 8 individual panels. The square sample panels (FIG. 2, 20) had the dimension of 200 mm×200 mm with the filament orientations being respectively parallel two its sides. The sample panels were fixed behind a target holder frame (not shown in FIG. 2) with one side parallel to the ground and maintained in place by a small piece of adhesive tape. The shooting distance was 10 meters and the shots were aimed at the center (22) of the panel (20). Projectile (24) used is 7.62×39 mm MSC (AK47) as for example supplied by Seller and Bellot, Czech Republic. The first shot is fired at a projectile speed (V50) at which it is anticipated that 50% of the shots would be stopped. If a stop is obtained, the next shot is fired at an anticipated speed being 40 m/s higher than the previous speed. If a perforation occurs, the next shot is fired at an anticipated speed 40 m/s lower than the previous speed. The speed of the projectile was measured 1 meter before the impact. The result for the experimentally obtained V50 value is the mean average of the four highest stops and the four lowest perforations. When there is a surplus on stops or penetrations, then these surpluses needed to be eliminated until the number of shots that resulted in a stop and the number of shots that resulted in a penetration are the same. This is accomplished by the elimination of the stops with lowest shooting velocity, or the elimination of the penetrations with the highest shooting velocity. In the unlikely event (when testing at 30 degree angle) that the bullet exits the panel at the edge, then this specific shot is invalid and should not be taken in account in the V50 calculation.
For V50↓ testing (FIG. 2a), the target holder (not shown) is positioned such that the line of fire (21) of the projectile (24) is orthogonal (angle 25 of 90°) to the panel (20) at the place of impact (22), i.e. the line of fire (21) is identical to the normal (23) at the place of impact (22).
For V50 [symbol] testing (FIG. 2b), the target holder (not shown) is rotated by an angle of 30° on its vertical axis, such that the line of fire (21) of the projectile (24) forms an angle (26) of 30° to the normal (23) at the place of impact (22). For the avoidance of doubt, the angle between the panel (20) and the line of fire (21) will hence be of 60°.

### Comparative Experiments 1.1-1.3

Two composite monolayers of polyethylene filaments with different areal density were prepared according to the process as described in WO2005066401. Here a multifilament yarn having 780 filaments with a yarn titer of 880 dtex and a tenacity of 4.25 N/tex was used to make a uni-directional (UD) mono-layer by feeding the yarn from several bobbins from a creel, spreading the filaments, and impregnating the filaments with an aqueous dispersion of Kraton® D1107 styrene-isoprene-styrene blockcopolymer as binder material. After drying the UD monolayers had respective areal densities of 34 g/m² and 49 g/m², both with a binder content of about 17 wt %. Four such unidirectional layers were cross plied in a 0° 90° 0° 90° sequence and consolidated for 30 seconds at a pressure of 30 bar and a temperature of 115° C. The resulting sheets, had an areal density of 136 g/m² and 196 g/m², respectively.

Sheets with the dimensions of 400 mm×400 mm were stacked to form an assembly having targeted panel areal densities of 9.8 and 12.5 kg/m². In total, 50, 72 and 92 sheets were used, with the alternating 0°/90° direction of filaments in adjacent monolayers maintained throughout the stack. The assembly of sheets was pressed at 16.5 MPa at 125° C. for 40 minutes followed by a cooling period of 20 min at 2 MPa and finally cut to 200 mm×200 mm panels for ballistic testing. The molded panels are reported as CE 1.1, 1.2 and 1.3 in table 1. The molded panels were shot with a 7.62×39 mm MSC (AK47) bullet in order to determine V50 ↓ and V50 [symbol] .

As can be observed from the results reported in table 2, the panel of CE 1.3 with high panel areal density shows no drop of V50 [symbol] , while the panels with a lower areal density show significant reduction of ballistic performance when shot at an angle of 300.

### Comparative Experiment 2.1

A 4-layer sheet was prepared following the process described in Example 2 of WO2019121545 employing a neutralized ethylene acrylic acid copolymer as binder. The obtained composite sheet with a matrix content of about 14 wt % and an areal density of about 128 g/m² were stacked, pressed and cut in line with Comparative Experiments 1 to form hard ballistic panels with an areal density of 9.8 kg/m². Details of the panels and material is provided in table 1. Said panels were each tested at perpendicular and 30° impact of an 7.62×39 mm MSC (AK47) bullet with results reported in table 2.

As can be observed, the panels show significant reduction of ballistic performance when shot at an angle of 30 degrees.

### Comparative Experiment 3.1 to 3.4

A precursor sheet was produced from multifilament yarns having 780 filaments with a yarn titer of 880 dtex and a tenacity of 4.25 N/tex. The yarns were unwound from bobbins on a tension controlled creel and passed through a reed. Subsequently the yarns were spread to form a gap-less bed of filaments with a width of 320 mm by feeding the yarns over a spreading unit. The spread yarns were then fed into a calender. The rolls of the calender had a diameter of 400 mm and the applied line pressure was 2000 N/cm. The line operated at a line speed of 8 m/min and at a roll surface temperature of 154° C. In the calender the yarns were fused into a fibrous monolayer. The monolayer was removed from the calender by the first roller-stand. A powder scattering unit was placed between the calender and the first roller-stand applying 10 wt. % of an ethylene based octene-1 plastomer with a density of 910 kg/m³ and a melt flow rate of 6.6 (190° C., 2.16 kg) to the upper surface of the monolayer. The monolayer with the powder was calendered at a temperature of about 130° C. and wound onto a roller stand.

For CE 3.1 to 3.3 a fibrous monolayer with a width of 320 mm and an areal density of 37 g/m² was produced. For CE 3.4 a fibrous monolayer with a width of 320 mm and an areal density of 33 g/m² was produced.

Five of said fibrous monolayers were aligned in parallel and abutting to form 1600 mm wide layer. A second, identical, layer of monolayers was formed on top of the first layer, with the adhesive layers of both monolayers facing upwards, but with the filaments of adjacent monolayers aligned perpendicularly. A two-layered, cross-plied precursor sheet having an areal density of 65 and 74 g/m² respectively resulted. These precursor sheets were cut into 200 mm×200 mm squares. Multiple 15 squares were stacked, making sure the alternating 0°/90° direction of the filaments was maintained. The stacks were processed into molded panels of different areal densities as detailed in table 1. The molding was performed at 16.5 MPa and 145° C. for 40 minutes followed by a cooling period of 20 min at 2 MPa.

The molded panels were tested at perpendicular and 30° impact with a 7.62×39 mm MSC (AK47) bullet in order to determine ballistic performances as reported in table 2.

As can be observed, the panel of CE 3.3 with a high panel areal density shows a very small drop of V50 [symbol] compared to its V50↓, while the panels with lower areal densities show significant reduction of ballistic performance when shot at an angle of 30 degrees. The V50 [symbol] performance of the panel with monolayer areal densities of 33 g/m² yet shows a slightly improved performance when shot under an angle of 300.

### Example 1.1 and 1.2

For Example 1.1, Comparative Experiment 1.2 was repeated except that the yarn fed from several bobbins from a creel was spread to result in an areal density of the unidirectional composite monolayer of 28 g/m², with a matrix content of about 17 wt %. The resulting 4-ply sheet had an areal density of 113 g/m². For Example 1.2 the amount of the yarn was further reduced to result in an areal density of the unidirectional monolayer of 24 g/m², still with a matrix content of about 17 wt %. Furthermore, only two unidirectional monolayers where cross-plied to provide a 2-ply sheet with an areal density of 48 g/m².

Respectively 87 and 204 sheets with the dimensions of 400 mm×400 mm were stacked and compressed to form assemblies having a targeted panel areal densities of 9.8 kg/m². The molded panels are reported as Ex 1.1 and 1.2 in table 1. The molded panels were shot with a 7.62×39 mm MSC (AK47) bullet in order to determine V50 at perpendicular and 30° conditions of which the results are reported in table 2.

As can be observed, the panel of Example 1.1 does not show a drop in ballistic performance anymore when shot under an angle of 30° while Ex 1.2 even shows a V50 at an angle of 30° higher than under a perpendicular conditions.

### Example 2.1 to 2.3

The Comparative Experiment 3.4 was repeated except that the areal density of the produced fibrous monolayer was further reduced by reducing the amount of yarn fed to the process. Accordingly fibrous monolayers with areal densities of 29 and 26 g/m² have been produced. To both monolayers 10 wt % of plastomer adhesive was added during the process.

For Examples 2.1 and 2.2 two-layered, cross-plied precursor sheets having areal densities of 57 and 52 g/m² respectively resulted. For Example 2.3 a four-layered cross-plied sheet was produced with an areal density of 104 g/m².

The produced 2- and 4-ply sheets were stacked to obtain a panel areal density of about 9.8 kg/m². Details of the ballistic panels are provided in table 1. The molded panels were shot with a 7.62×39 mm MSC (AK47) bullet in order to determine V50 at perpendicular and under a 30° angle. The results are reported in table 2.

As can be observed, all the panels of Ex 2.1, Ex 2.2 and Ex 2.3 show equal or slight improved ballistic performance when shot under an angle. This stands in contrast to Comparative Experiment 3.2 and 3.4 with fewer monolayers, where a drop in V50 [symbol] of 15 and 6%, respectively, were observed.

TABLE 1

| | | | | Monolayers/ | | | | | PE filament |
|---|---|---|---|---|---|---|---|---|---|
| | Panel AD | Sheets/ | Sheet AD | sheet | Monolayer | Monolayers/ | | Binder | AD |
| | [kg/m²] | panel | [g/m²] | [g/m²] | AD | panel | Type | [wt %] | [g/m²] |
| Ex 1.1 | 9.78 | 87 | 113 | 4 | 28 | 348 | Kraton | 17% | 23.2 |
| Ex 1.2 | 9.78 | 204 | 48 | 2 | 24 | 408 | Kraton | 5% | 22.8 |
| Ex 2.1 | 9.78 | 172 | 57 | 2 | 29 | 344 | Plastomer | 17% | 24.1 |
| Ex 2.2 | 9.78 | 94 | 52 | 2 | 26 | 376 | Plastomer | 10% | 23.4 |
| Ex 2.3 | 9.78 | 94 | 104 | 4 | 26 | 376 | Plastomer | 10% | 23.4 |
| CE 1.1 | 9.78 | 50 | 196 | 4 | 49 | 200 | Kraton | 17% | 40.7 |
| CE 1.2 | 9.78 | 72 | 136 | 4 | 34 | 288 | Kraton | 17% | 28.2 |
| CE 1.3 | 12.5 | 92 | 136 | 4 | 34 | 368 | Kraton | 17% | 28.2 |
| CE 2.1 | 9.78 | 76 | 128 | 4 | 32 | 306 | Polyolefin | 14% | 27.5 |
| CE 3.1 | 8.8 | 119 | 74 | 2 | 37 | 238 | Plastomer | 10% | 33.3 |
| CE 3.2 | 9.78 | 132 | 74 | 2 | 37 | 264 | Plastomer | 10% | 33.3 |
| CE 3.3 | 12.5 | 169 | 74 | 2 | 37 | 338 | Plastomer | 10% | 33.3 |
| CE 3.4 | 9.78 | 150 | 65 | 2 | 33 | 300 | Plastomer | 10% | 29.3 |

TABLE 2

| | V50↓ (0°) | V50 [symbol] (30°) | Δ V50 |
|---|---|---|---|
| | [m/s] | [m/s] | [%] |
| Ex 1.1 | 751 | 754 | 0% |
| Ex 1.2 | 638 | 719 | 13% |
| Ex 2.1 | 788 | 805 | 2% |
| Ex 2.2 | 861 | 869 | 1% |
| Ex 2.3 | 856 | 846 | −1% |
| CE 1.1 | 771 | 628 | −19% |
| CE 1.2 | 731 | 648 | −11% |
| CE 1.3 | 880 | 885 | 1% |
| CE 2.1 | 654 | 578 | −12% |
| CE 3.1 | 769 | 660 | −14% |
| CE 3.2 | 845 | 718 | −15% |
| CE 3.3 | 968 | 944 | −2% |
| CE 3.4 | 864 | 811 | −6% |

1. A ballistic-resistant molded article having an areal density of at least 7.0 and at most 12.0 kg/m², comprising a consolidated stack of fibrous monolayers, each fibrous monolayer containing unidirectionally aligned high tenacity polyethylene filaments, whereby the direction of orientation of the polyethylene filaments in two adjacent fibrous monolayers in the stack differs by at least 40 and up to 90 degree, the polyethylene filaments having a tenacity of at least 3.5 N/tex, wherein the molded article comprises between 5.0 and 20 wt % of a binder, based on the total weight of the molded article,
characterized in that the molded article comprises at least 330 of said fibrous monolayers.

2. The ballistic-resistant molded article of claim 1 wherein the molded article has an areal density of polyethylene filaments of between 6.0 and 10.0 kg/m².

3. The ballistic-resistant molded article of claim 1 wherein the fibrous monolayers have an areal density of between 6 and 30 g/m², preferably between 8 and 28 g/m², more preferably between 10 and 26 g/m², and most preferably between 12 and 24 g/m².

4. The ballistic-resistant molded article of claim 1 wherein the fibrous monolayers have an areal density of polyethylene filaments between 4 and 28 g/m², preferably between 6 and 26 g/m², more preferably between 8 and 25 g/m², and most preferably between 10 and 24 g/m².

5. The ballistic-resistant molded article of claim 1 wherein the article comprises between 330 and 600, preferably 350 and 550 monolayers, more preferably between 370 and 500 monolayers.

6. The ballistic-resistant molded article of claim 1 wherein the fibrous monolayers are composite monolayers of the unidirectionally aligned high tenacity polyethylene filaments and the binder.

7. The ballistic-resistant molded article of claim 1, wherein the fibrous monolayers are substantially free of binder and wherein adjacent fibrous monolayers are adhered to each other by layers of the binder.

8. The ballistic-resistant molded article of claim 1 wherein the molded article has a V50 when shot under perpendicular conditions (V50↓) of at least 600 m/s when tested against an AK47 7.62×39 mm MSC projectile.

9. The ballistic-resistant molded article of claim 1 wherein the molded article has a V50 when shot at an angle (26) of 300 (V50 [symbol] ) of at least 580 m/s when tested against an AK47 7.62×39 mm MSC projectile.

10. The ballistic-resistant molded article of claim 8 wherein the ratio of the V50 [symbol] to V50↓ is at least 0.95, preferably 0.98, more preferably at least 1.00 and most preferably at least 1.05.

11. A ballistic-resistant sheet comprising at least 2 fibrous monolayers, each fibrous monolayer containing unidirectionally aligned high tenacity polyethylene filaments, whereby the direction of orientation between the polyethylene filaments of two adjacent fibrous monolayers in the sheet differ by at least 40 and up to 90 degree, the polyethylene filaments having a tenacity of at least 3.5 N/tex, wherein the ballistic-resistant sheet comprises between 5.0 and 20 wt % of a binder based on the total weight of the ballistic-resistant sheet, wherein the fibrous monolayers are substantially free of binder and wherein adjacent fibrous monolayers are adhered to each other by a layer of the binder, wherein said ballistic-resistant sheet has an areal density of between 6 and 30 g/m² per polyethylene filament monolayer present in the ballistic-resistant sheet, preferably between 8 and 28 g/m² and more preferably between 10 and 26 g/m².

12. The ballistic-resistant sheet of claim 11 wherein the ballistic-resistant sheet comprises between 7.0 and 14 wt % of the binder based on the total weight of the ballistic-resistant sheet.

13. A ballistic-resistant molded article wherein said molded article has an areal density of between 7.0 and 12.0 kg/m² and comprising a consolidated stack of fibrous monolayers, each fibrous monolayer containing unidirectionally aligned high tenacity polyethylene filaments, whereby the direction of orientation between the polyethylene filaments of two adjacent fibrous monolayers in the stack differs by at least 40 and up to 90 degree, the polyethylene filaments having a tenacity of at least 3.5 N/tex, wherein the molded article comprises between 5.0 and 20 wt % of a binder based on the total weight of the molded article, and wherein the ratio of the V50, to V50 of the ballistic-resistant molded article is at least 0.95, preferably 0.98, more preferably at least 1.00 and most preferably at least 1.05.

14. The ballistic-resistant molded article of claim 13 wherein the fibrous monolayers are composite monolayers of the unidirectionally aligned high tenacity polyethylene filaments and the binder.

15. The ballistic-resistant molded article of claim 14 wherein the fibrous monolayers are substantially free of binder and wherein the adjacent fibrous monolayers are adhered to each other by layers of the binder.
